(19) United States
(12) Patent Application Publication
(10) Pub. No.: US 2025/0385767 A1
(43) Pub. Date: Dec. 18, 2025

(54) TRANSMISSION OF COMMON DATA STREAMS IN COMMUNICATION SYSTEM

(71) Applicant: HUAWEI TECHNOLOGIES CO., LTD., Shenzhen (CN)

(72) Inventors: Dzevdan Kapetanovic, Lund (SE); Sha Hu, Lund (SE); Hongxiang Xie, Beijing (CN); Hao Wang, Beijing (CN)

(21) Appl. No.: 19/314,016

(22) Filed: Aug. 29, 2025

Related U.S. Application Data
(63) Continuation of application No. PCT/CN2023/079148, filed on Mar. 1, 2023.

(51) Int. Cl. H04L 5/00

(52) U.S. Cl. CPC H04L 5/0044; H04L 5/0053

(57) ABSTRACT

Embodiments of the invention relate to transmission of common data streams from a network access node (100) to a plurality of client devices (300a, 300b, . . . , 300n) in a communication system (500). The network access node (100) transmits data streams (510) to the plurality of client devices (300). The data streams (510) comprises at least one common data stream addressed to the plurality of client devices (300a, 300b, . . . , 300n). The network access node (100) further transmits a control information (520) to the plurality of client devices (300a, 300b, . . . , 300n). The control information (510) indicates the meaning of the common data stream and/or instructions for what to do with the common data stream. Based on the control information (520), each the client device (300) can then process the received common data stream in an efficient way. Furthermore, embodiments of the invention also relate to corresponding methods and a computer program.

### CROSS-REFERENCE TO RELATED APPLICATIONS

This application is a continuation of International Application No. PCT/CN2023/079148, filed on Mar. 1, 2023, the disclosure of which is hereby incorporated by reference in its entirety.

### TECHNICAL FIELD

Embodiments of the invention relate to transmission of common data streams from a network access node to a plurality of client devices in a communication system. Furthermore, embodiments of the invention also relate to corresponding methods and a computer program.

### BACKGROUND

Rate splitting multiple access (RSMA) is a proposed downlink multi-user multiple-input multiple-output (MU-MIMO) transmission scheme for 6G in 3GPP. Its main advantages compared to current downlink MU-MIMO transmission in 5G is robustness to imperfect channel state information transmitter (CSIT), which is due to transmission of a common data stream s_{c} that is decoded by all user equipment (UEs) served in the downlink transmission. The common data stream s_{c} carries bits to each UE served in the downlink transmission and it is precoded with precoder p_{c}. Added to p_{c}s_{c} is the conventional downlink MU-MIMO signal which carries individual data streams s₁, . . . , s_{K} to each UE precoded by their corresponding precoders p₁, . . . , p_{K}.

At the receiver of UE k, the common data stream is decoded first, followed by the individual data stream sₖ to UE k. The decoding in this order can provide massive improvements of RSMA over conventional downlink MU-MIMO in case of imperfect CSIT.

### SUMMARY

An objective of embodiments of the invention is to provide a solution which mitigates or solves the drawbacks and problems of conventional solutions.

Another objective of embodiments of the invention is to provide a solution for efficient handling of common data streams by indicating meaning and/or instruction associated with the common data streams.

The above and further objectives are solved by the subject matter of the independent claims. Further embodiments of the invention can be found in the dependent claims.

According to a first aspect of the invention, the above mentioned and other objectives are achieved with a network access node for a communication system, the network access node being configured to:
transmit data streams to a plurality of client devices, the data streams comprising: at least one common data stream addressed to the plurality of client devices and a plurality of individual data streams, each individual data stream being addressed to an individual client device among the plurality of client devices; and
transmit a control information to the plurality of client devices, the control information indicating one or more types of the common data stream and/or one or more instructions associated with the common data stream.

An advantage of the network access node according to the first aspect is that the control information provides information enabling the common data stream to be used efficiently. The transmission rate to the plurality of client devices can thereby be improved and/or additional broadcast data or system relevant data can be transmitted to the plurality of client devices for a given fixed rate.

In an implementation form of a network access node according to the first aspect, the network access node is configured to:
transmit the control information previous to or during the transmission of the data streams.

An advantage with this implementation form is that the network access node can provide the control information indicating how to handle the common data stream to the plurality of client devices before or together with the common data stream, allowing the plurality of client devices to process the common data stream accordingly.

In an implementation form of a network access node according to the first aspect, the network access node is configured to:
transmit the control information in the common data stream and/or in the plurality of individual data streams.

An advantage with this implementation form is that the control information can be transmitted in the data stream. No separate control signal is thereby needed which reduces signaling overhead and reduces the impact on the standard.

In an implementation form of a network access node according to the first aspect, the network access node is configured to:
transmit the control information in a control signal.

An advantage with this implementation form is that the control information can be transmitted using a dedicated control signal separate from the transmission of the data streams. The data streams can thereby be full used for relevant data and there is no rate loss during the data stream transmission.

In an implementation form of a network access node according to the first aspect, the control signal comprises a downlink control information.

An advantage with this implementation form is that an existing control signal can be used, thereby simplifying the implementation.

In an implementation form of a network access node according to the first aspect, the control information is given in a bit map format.

An advantage with this implementation form is that a simple and standardized method of conveying the control information can be used.

In an implementation form of a network access node according to the first aspect, the bit map format is derived from a predefined table.

An advantage with this implementation form is that a simple and standardized method of deriving the control information can be used.

In an implementation form of a network access node according to the first aspect, the one or more types of the common data stream comprise any of broadcast data and individual data.

An advantage with this implementation form is that the common data stream can be more general than just individual bits to each client device. The common data stream can be anything between only broadcast data (to all client devices or to a subset of client devices) to only individual data to the client devices. This provides more flexibility in the usage of the common bits in the common data stream.

In an implementation form of a network access node according to the first aspect, the one or more types of the common data stream comprise any of positioning data and data for artificial intelligence/machine learning.

An advantage with this implementation form is that additional information related to positioning and/or artificial intelligence/machine learning can be provided to the plurality of client devices, thereby improving positioning and/or artificial intelligence/machine learning training at the plurality of client devices.

In an implementation form of a network access node according to the first aspect, the one or more instructions associated with the common data stream comprise any of discard at least one part of the common data stream addressed for another client device and relay at least one part of the common data stream to another client device.

An advantage with this implementation form is that the network access node can provide instruction to the plurality of client devices on how to handle parts of the common data stream addressed to other client devices allowing the common data stream to be efficiently handled.

In an implementation form of a network access node according to the first aspect, the transmission of the data streams is a rate splitting multiple access transmission.

An advantage with this implementation form is that a rate splitting multiple access transmission can be performed with improved transmission rate to the plurality of client devices or can be used to transmit additional broadcast data or system relevant data to the plurality of client devices for a given fixed rate.

According to a second aspect of the invention, the above mentioned and other objectives are achieved with a client device for a communication system, the client device being configured to:
receive at least one common data stream and at least one individual data stream from a network access node, the common data stream being addressed to a plurality of client devices and the individual data stream being addressed to the client device;
receive a control information from the network access node, the control information indicating one or more types of the common data stream and/or one or more instructions associated with the common data stream; and
process at least one part of the common data stream based on the control information.

An advantage of the client device according to the second aspect is that the control information provides information enabling the client device to use the common data stream efficiently. The transmission rate to the client device can thereby be improved and/or additional broadcast data or system relevant data can be transmitted to the client device for a given fixed rate.

In an implementation form of a client device according to the second aspect, the client device is configured to:
receive the control information previous to or during the transmission of the data streams.

An advantage with this implementation form is that control information indicating how to handle the common data stream is received before or together with the common data stream, allowing the client device to process the common data stream accordingly.

In an implementation form of a client device according to the second aspect, the client device is configured to:
receive the control information in the common data stream and/or in the individual data stream.

An advantage with this implementation form is that the control information can be received with the data stream. No separate control signal is thereby needed which reduces signaling overhead and reduces the impact on the standard.

In an implementation form of a client device according to the second aspect, the client device is configured to:
receive the control information in a control signal.

An advantage with this implementation form is that the control information can be received using a dedicated control signal separate from the transmission of the data streams. The data streams can thereby be full used for relevant data and there is no rate loss during the data stream transmission due to control signaling.

In an implementation form of a client device according to the second aspect, the control signal comprises a downlink control information.

An advantage with this implementation form is that an existing control signal can be used, thereby simplifying the implementation.

In an implementation form of a client device according to the second aspect, the control information is given in a bit map format.

An advantage with this implementation form is that a simple and standardized method of conveying the control information can be used.

In an implementation form of a client device according to the second aspect, the bit map format is derived from a predefined table.

An advantage with this implementation form is that a simple and standardized method of deriving the control information can be used.

In an implementation form of a client device according to the second aspect, the one or more types of the common data stream comprise any of broadcast data and individual data.

An advantage with this implementation form is that the common data stream can be more general than just individual bits to each client device. The common data stream can be anything between only broadcast data (to all client devices or to a subset of client devices) to only individual data to the client devices. This provides more flexibility in the usage of the common bits in the common data stream.

In an implementation form of a client device according to the second aspect, the one or more types of the common data stream comprise any of positioning data and data for artificial intelligence/machine learning.

An advantage with this implementation form is that the client device receives additional information related to positioning and/or artificial intelligence/machine learning which can be used to improve positioning and/or artificial intelligence/machine learning training at the client device.

In an implementation form of a client device according to the second aspect, the instruction associated with the common data stream comprise any of discard at least one part of the common data stream addressed for another client device and relay at least one part of the common data stream to another client device; and the client device is configured to:
discard at least one part of the common data stream addressed for another client device, or
relay at least one part of the common data stream to another client device.

An advantage with this implementation form is that the client device receives instruction on how to handle parts of the common data stream addressed to other client devices. Thereby, improving the use of the common data stream and increasing the flexibility. The client device can pick out the bits from the common bit stream that are only relevant to itself and discards the rest or save parts of the common data stream in a buffer to later relay it to the other client device specified by the control information from the network access node.

According to a third aspect of the invention, the above mentioned and other objectives are achieved with a method for a network access node, the method comprises
transmitting data streams to a plurality of client devices, the data streams comprising: at least one common data stream addressed to the plurality of client devices and a plurality of individual data streams, each individual data stream being addressed to an individual client device among the plurality of client devices; and
transmitting a control information to the plurality of client devices, the control information indicating one or more types of the common data stream and/or one or more instructions associated with the common data stream.

The method according to the third aspect can be extended into implementation forms corresponding to the implementation forms of the network access node according to the first aspect. Hence, an implementation form of the method comprises the feature(s) of the corresponding implementation form of the network access node.

The advantages of the methods according to the third aspect are the same as those for the corresponding implementation forms of the network access node according to the first aspect.

According to a fourth aspect of the invention, the above mentioned and other objectives are achieved with a method for a client device, the method comprises
receiving at least one common data stream and at least one individual data stream from a network access node, the common data stream being addressed to a plurality of client devices and the individual data stream being addressed to the client device;
receiving a control information from the network access node, the control information indicating one or more types of the common data stream and/or one or more instructions associated with the common data stream; and
processing at least one part of the common data stream based on the control information.

The method according to the fourth aspect can be extended into implementation forms corresponding to the implementation forms of the client device according to the second aspect. Hence, an implementation form of the method comprises the feature(s) of the corresponding implementation form of the client device.

The advantages of the methods according to the fourth aspect are the same as those for the corresponding implementation forms of the client device according to the second aspect.

Embodiments of the invention also relate to a computer program, characterized in program code, which when run by at least one processor causes the at least one processor to execute any method according to embodiments of the invention. Further, embodiments of the invention also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the invention will be apparent from the following detailed description.

### BRIEF DESCRIPTION OF THE DRAWINGS

The appended drawings are intended to clarify and explain different embodiments of the invention, in which:

FIG. 1 shows a network access node according to an embodiment of the invention;

FIG. 2 shows a flow chart of a method for a network access node according to an embodiment of the invention;

FIG. 3 shows a client device according to an embodiment of the invention;

FIG. 4 shows a flow chart of a method for a client device according to an embodiment of the invention;

FIG. 5 shows a communication system according to an embodiment of the invention; and

FIG. 6 shows transmission of data streams and control information according to an embodiment of the invention.

### DETAILED DESCRIPTION

A UE k receiving a RSMA transmission decodes the common data stream s_{c} first. When the UE k decodes the common data stream s_{c}, the UE also obtains the bit estimates W̅_{c,j}, j≠k, of the common bits of the other UEs. Hence, each UE has information about the common bits intended to other UEs in the downlink RSMA transmission.

According to embodiments of the invention information about the common bits can be utilized to further improves the downlink communication. This opens up the possibility of improving the overall system performance beyond the improvement offered solely by RSMA transmission. Instead of discarding common bits intended to the other UEs in a common data stream from a base station, the UEs are enabled to use the decoded common bits in a useful way. To achieve this, the base station indicates to the receiving UEs what to do with the decoded common bits in a RSMA transmission which conventionally are only intended to each UE individually. In this way, the UEs can use the decoded common bits in a way that favors the overall system performance.

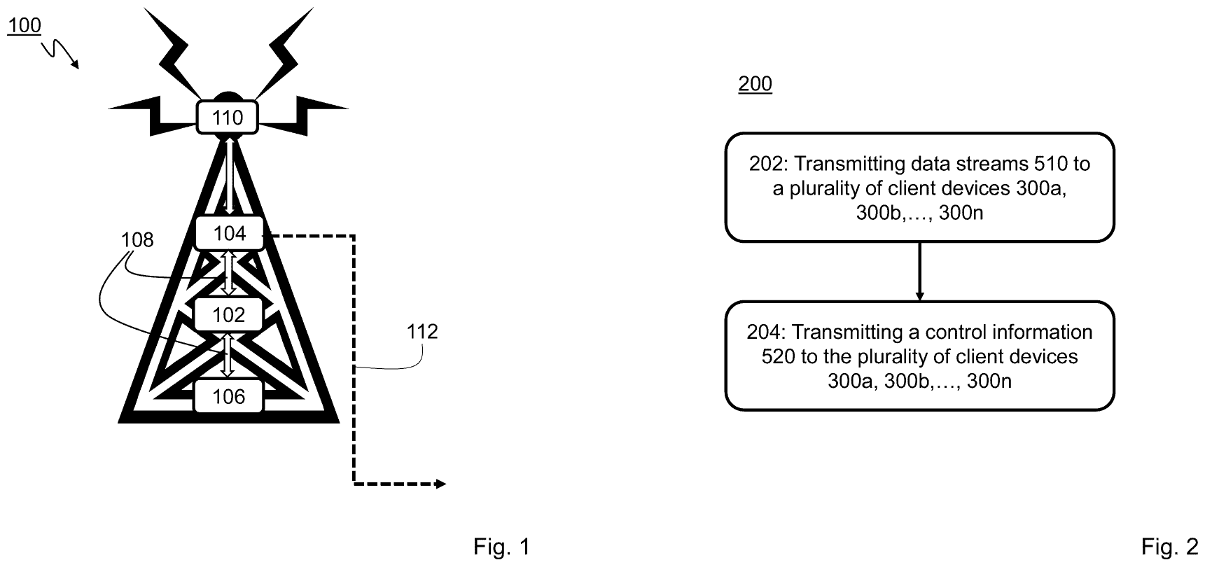

FIG. 1 shows a network access node 100 according to an embodiment of the invention. In the embodiment shown in FIG. 1, the network access node 100 comprises a processor 102, a transceiver 104 and a memory 106. The processor 102 is coupled to the transceiver 104 and the memory 106 by communication means 108 known in the art. The network access node 100 may be configured for wireless and/or wired communications in a communication system. The wireless communication capability may be provided with an antenna or antenna array 110 coupled to the transceiver 104, while the wired communication capability may be provided with a wired communication interface 112 e.g., coupled to the transceiver 104.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 104 may be a transceiver circuit, a power controller, or an interface providing capability to communicate with other communication modules or communication devices. The transceiver 104, memory 106 and/or processor 102 may be implemented in separate chipsets or may be implemented in a common chipset.

That the network access node 100 is configured to perform certain actions can in this disclosure be understood to mean that the network access node 100 comprises suitable means, such as e.g., the processor 102 and the transceiver 104, configured to perform the actions.

According to embodiments of the invention the network access node 100 is configured to transmit data streams 510 to a plurality of client devices 300a, 300b, . . . , 300n, the data streams 510 comprising: at least one common data stream addressed to the plurality of client devices 300a, 300b, . . . , 300n and a plurality of individual data streams, each individual data stream being addressed to an individual client device 300n among the plurality of client devices 300. The network access node 100 is further configured to transmit a control information 520 to the plurality of client devices 300a, 300b, . . . , 300n, the control information 520 indicating one or more types of the common data stream and/or one or more instructions associated with the common data stream.

Furthermore, in an embodiment of the invention, the network access node 100 for a communication system 500 comprises a transceiver configured to: transmit data streams 510 to a plurality of client devices 300a, 300b, . . . , 300n, the data streams 510 comprising: at least one common data stream addressed to the plurality of client devices 300a, 300b, . . . , 300n and a plurality of individual data streams, each individual data stream being addressed to an individual client device 300n among the plurality of client devices 300; and transmit a control information 520 to the plurality of client devices 300a, 300b, . . . , 300n, the control information 520 indicating one or more types of the common data stream and/or one or more instructions associated with the common data stream.

Moreover, in yet another embodiment of the invention, the network access node 100 for a communication system 500 comprises a processor and a memory having computer readable instructions stored thereon which, when executed by the processor, cause the processor to: transmit data streams 510 to a plurality of client devices 300a, 300b, . . . , 300n, the data streams 510 comprising: at least one common data stream addressed to the plurality of client devices 300a, 300b, . . . , 300n and a plurality of individual data streams, each individual data stream being addressed to an individual client device 300n among the plurality of client devices 300; and transmit a control information 520 to the plurality of client devices 300a, 300b, . . . , 300n, the control information 520 indicating one or more types of the common data stream and/or one or more instructions associated with the common data stream.

FIG. 2 shows a flow chart of a corresponding method 200 which may be executed in a network access node 100, such as the one shown in FIG. 1. The method 200 comprises transmitting 202 data streams 510 to a plurality of client devices 300a, 300b, . . . , 300n, the data streams 510 comprising: at least one common data stream addressed to the plurality of client devices 300a, 300b, . . . , 300n and a plurality of individual data streams, each individual data stream being addressed to an individual client device 300n among the plurality of client devices 300. The method 200 further comprises transmitting 204 a control information 520 to the plurality of client devices 300a, 300b, . . . , 300n, the control information 520 indicating one or more types of the common data stream and/or one or more instructions associated with the common data stream.

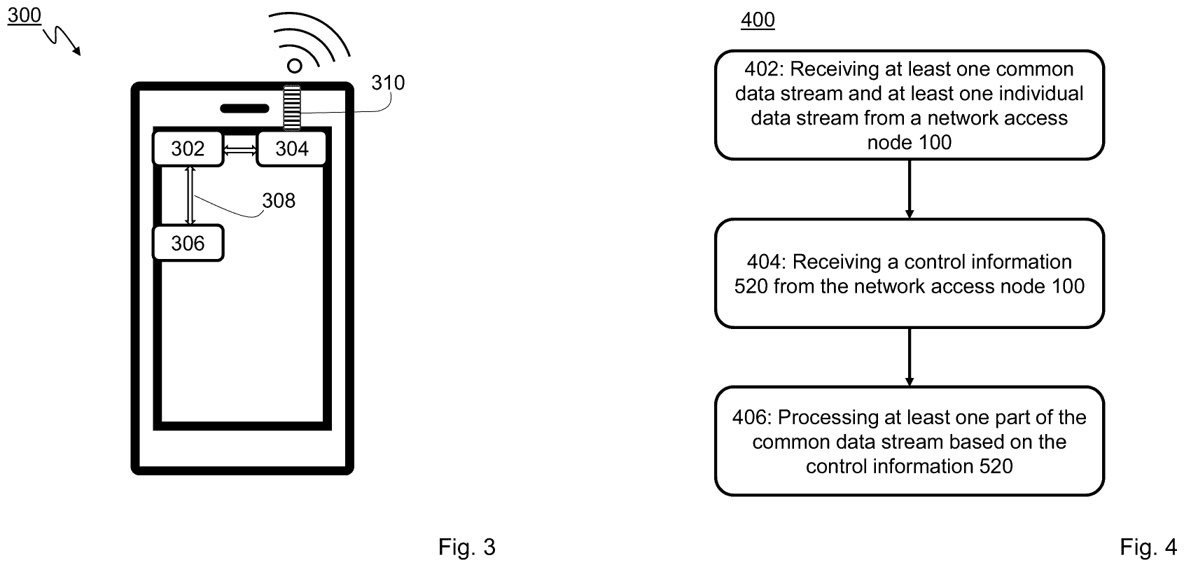

FIG. 3 shows a client device 300 according to an embodiment of the invention. In the embodiment shown in FIG. 3, the client device 300 comprises a processor 302, a transceiver 304 and a memory 306. The processor 302 is coupled to the transceiver 304 and the memory 306 by communication means 308 known in the art. The client device 300 further comprises an antenna or antenna array 310 coupled to the transceiver 304, which means that the client device 300 is configured for wireless communications in a communication system.

The processor 302 may be referred to as one or more general-purpose CPU, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 304 may be a transceiver circuit, a power controller, or an interface providing capability to communicate with other communication modules or communication devices, such as network nodes and network servers. The transceiver 304, the memory 306 and/or the processor 302 may be implemented in separate chipsets or may be implemented in a common chipset.

That the client device 300 is configured to perform certain actions can in this disclosure be understood to mean that the client device 300 comprises suitable means, such as e.g., the processor 302 and the transceiver 304, configured to perform the actions.

According to embodiments of the invention the client device 300 is configured to receive at least one common data stream and at least one individual data stream from a network access node 100, the common data stream being addressed to a plurality of client devices 300a, 300b, . . . , 300n and the individual data stream being addressed to the client device 300. The client device 300 is further configured to receive a control information 520 from the network access node 100, the control information 520 indicating one or more types of the common data stream and/or one or more instructions associated with the common data stream. Furthermore, the client device 300 is configured to process at least one part of the common data stream based on the control information 520.

Furthermore, in an embodiment of the invention, the client device 300 for a communication system 500 comprises: a transceiver configured to receive at least one common data stream and at least one individual data stream from a network access node 100, the common data stream being addressed to a plurality of client devices 300a, 300b, . . . , 300n and the individual data stream being addressed to the client device 300, and receive a control information 520 from the network access node 100, the control information 520 indicating one or more types of the common data stream and/or one or more instructions associated with the common data stream; and a processor configured to process at least one part of the common data stream based on the control information 520.

Moreover, in yet another embodiment of the invention, the client device 300 for a communication system 500 comprises a processor and a memory having computer readable instructions stored thereon which, when executed by the processor, cause the processor to: receive at least one common data stream and at least one individual data stream from a network access node 100, the common data stream being addressed to a plurality of client devices 300a, 300b, . . . , 300n and the individual data stream being addressed to the client device 300; receive a control information 520 from the network access node 100, the control information 520 indicating one or more types of the common data stream and/or one or more instructions associated with the common data stream; and process at least one part of the common data stream based on the control information 520.

FIG. 4 shows a flow chart of a corresponding method 400 which may be executed in a client device 300, such as the one shown in FIG. 3. The method 400 comprises receiving 402 at least one common data stream and at least one individual data stream from a network access node 100, the common data stream being addressed to a plurality of client devices 300a, 300b, . . . , 300n and the individual data stream being addressed to the client device 300. The method 400 further comprises receiving 404 a control information 520 from the network access node 100, the control information 520 indicating one or more types of the common data stream and/or one or more instructions associated with the common data stream. Furthermore, the method 400 comprises processing 406 at least one part of the common data stream based on the control information 520.

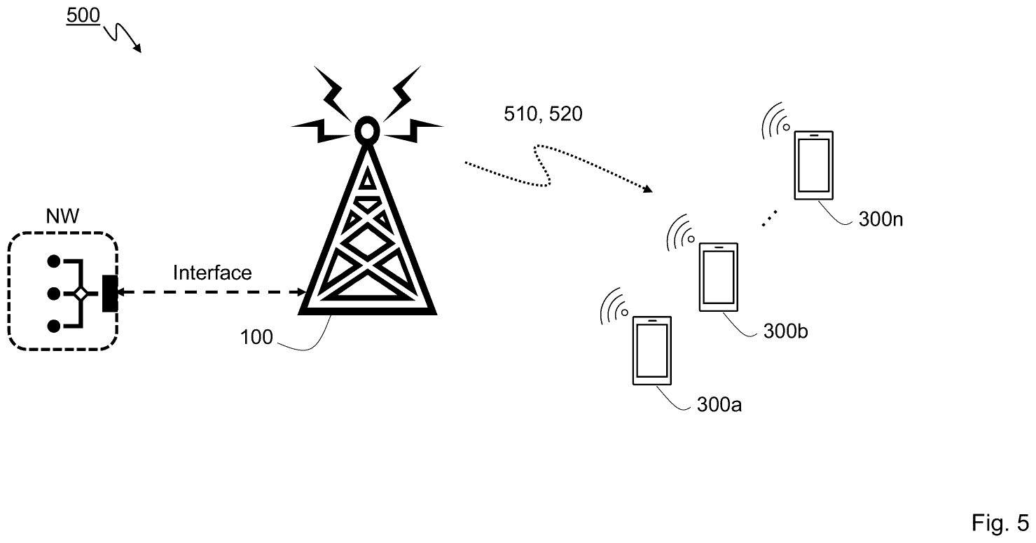

FIG. 5 shows a communication system 500 according to an embodiment of the invention. The communication system 500 in the disclosed embodiment comprises a network access node 100 and a plurality of client devices 300a, 300b, . . . , 300n configured to communicate and operate in the communication system 500. The network access node 100 may be connected to a network NW such as e.g., a core network over a communication interface. The communication system 500 may be a communication system according to the 3GPP standard such as e.g., a 6G or 5G system in which case the plurality of client devices 300a, 300b, . . . , 300n may be user equipment (UEs) and the network access node 100 may be a next generation node B (gNB) but the invention is not limited thereto.

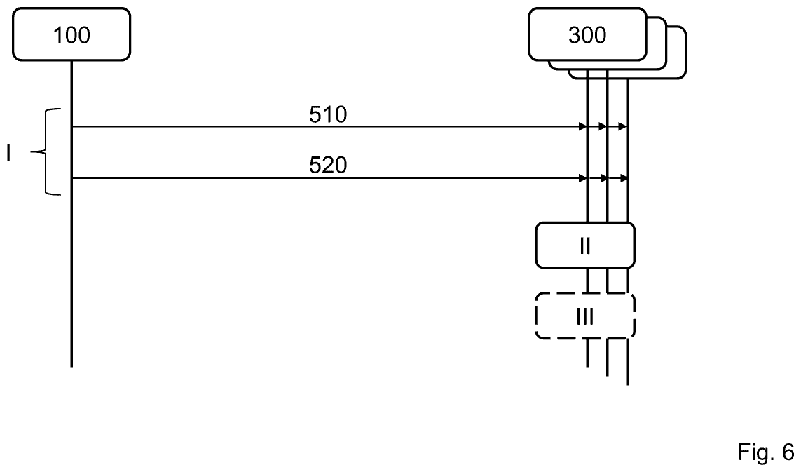

According to embodiments of the invention the network access node 100 transmits data streams 510 and control information 520 to the plurality of client devices 300a, 300b, . . . , 300n, as shown in FIG. 6. The data streams 510 comprises at least one common data stream addressed to the plurality of client devices 300a, 300b, . . . , 300n and may e.g., be a RSMA transmission. The control information 520 indicates one or more types of the common data stream and/or one or more instructions associated with the common data stream and enable the plurality of client devices 300a, 300b, . . . , 300n to process the common data stream in an efficient way. For example, instead of discarding parts of the common data stream intended to other client devices 300, the client devices 300 may use these parts of the common data stream in a constructive manner.

FIG. 6 shows transmission of data streams 510 and control information 520 from the network access node 100 to the plurality of client devices 300a, 300b, . . . , 300n according to an embodiment of the invention.

In step I in FIG. 6, the network access node 100 transmits data streams 510 and associated control information 520 to the plurality of client devices 300a, 300b, . . . , 300n. The data streams 510 comprises at least one common data stream addressed to the plurality of client devices 300a, 300b, . . . , 300n and a plurality of individual data streams, each individual data stream being addressed to an individual client device 300n among the plurality of client devices 300a, 300b, . . . , 300n. In embodiments, the transmission of the data streams 510 is a RSMA transmission.

The control information 520 indicates one or more types of the common data stream and/or one or more instructions associated with the common data stream. In embodiments, the network access node 100 transmit the control information 520 previous to the transmission of the data streams 510. Thus, the network access node 100 may transmit the control information 520 to the plurality of client devices 300a, 300b, . . . , 300n before transmitting the data streams 510 to the plurality of client devices 300a, 300b, . . . , 300n. The network access node 100 may transmit the control information 520 in a control signal. The control signal may e.g., comprise or be a downlink control information (DCI). In a 3GPP implementation, the control information 520 may be signaled individually to each client device 300 in DCI of a physical downlink control channel (PDCCH). New information bits may be introduced in DCI to indicate the control information 520.

In embodiments, the network access node 100 may instead transmit the control information 520 during the transmission of the data streams 510. The network access node 100 may hence transmit the control information 520 together with the data streams 510 to the plurality of client devices 300a, 300b, . . . , 300n, i.e., the control information 520 may be comprised in or indicated in the data streams 510. The network access node 100 may transmit the control information 520 in the common data stream and/or in the plurality of individual data streams. Additional information bits indicating the control information 520 may e.g., be added to the common data stream and/or the plurality of individual data streams. This reduces the signaling overhead to convey the control information 520 but at a cost of rate loss during the transmission of the data streams 510.

With the control information 520, the network access node 100 can indicate to the client devices 300 the meaning of the common data stream and/or how to handle the common data stream in the transmitted data streams 510. The one or more types of the common data stream may comprise any of broadcast data and individual data. The type of the common data stream may hence indicate whether the common data stream is indicated for the plurality of client devices 300a, 300b, . . . , 300n or for an individual client device 300n. The one or more types of the common data stream may further comprise any of positioning data and data for artificial intelligence (AI)/machine learning (ML). In this way, the client device 300 may from the control information 520 derive the type of information comprised in the common data stream and hence the use case for the common data stream, e.g., what the common data stream can be used for. Based on the type of the common data stream, the client device 300 may e.g., determine that the common data stream comprises positioning data and/or data for AI/ML and use the common data stream for positioning purposes or training of an AI/ML model.

The one or more instructions associated with the common data stream may comprise any of discard at least one part of the common data stream addressed for another client device and relay at least one part of the common data stream to another client device. In this way, the network access node 100 may instruct the plurality of client devices 300a, 300b, . . . , 300n how to handle information in the common data stream. For example, if a first client device 300a has a bad link to the network access node 100, the network access node 100 may use the control information 520 to instruct the plurality of client devices 300a, 300b, . . . , 300n to act as a relay node for the common data stream to the first client device 300a. When the common data stream comprises individual bits to each client device 300, the network access node 100 may further use the control information 520 to indicate that the client devices 300 can discard bits of the common data stream which are not intended for themselves.

In embodiments, the control information 520 is given in a bit map format. The bit map format may comprise one or more bit fields, where each bit field may comprise a bit pattern mapped to a type of the common data stream and/or an instruction associated with the common data stream. In this way, the meaning of the bits of the common data stream and/or instructions on how to handle the bits of the common data stream can be provided by the bit map format. The bit map format may in embodiments be derived from a predefined table. The bit map format may e.g., be derived from one or more tables predefined in a standard such as the 3GPP specifications. Thus, the one or more predefined tables may be known to both the network access node 100 and the client device 300, e.g., pre-configured in the network access node 100 and the client device 300. As previously described, the control information 520 may be transmitted as a control signal or in the data streams 510. The information bits indicating the control information 520 may hence be comprised in the control signal or in the data stream 510 and be interpreted based on the bit map format and/or the one or more predefined tables.

Table 1 and 2 below show examples of predefined tables according to an embodiment of the invention. Table 1 comprises the bit map format for types of the common data stream and table 2 the bit map format for instructions associated with the common data stream. In embodiments, the types of the common data stream and instructions associated with the common data stream may instead be combined in one predefined table which comprises instructions for each type of the common data stream.

TABLE 1

| Bits | Type of the common data stream |
|---|---|
| 00 . . . 01 | Common bits of each client device 300 indicate the position |
| | of the client device 300 |
| 00 . . . 10 | Common bits of each client device 300 are private information |
| | for the client device 300 |
| . . . | |
| 11 . . . 11 | Common bits represent input and label for AI training at the |
| | client devices 300 |

TABLE 2

| Bits | Instructions associated with the common data stream |
|---|---|
| 00 . . . 01 | No action |
| . . . | |
| 11 . . . 11 | Feedback common bits of client device j |

With reference to FIG. 6, the plurality of client devices 300a, 300b, . . . , 300n receives the data streams 510 and the control information 520 from the network access node 100. Each client device 300 hence receive at least one common data stream and at least one individual data stream from the network access node 100, as well as the one or more types of the common data stream and/or one or more instructions associated with the common data stream indicated in the control information 520. As previously described, the network access node 100 may transmit the control information 520 in different ways and the client device 300 may hence receive the control information 520 previous to or during the transmission of the data streams 510. The client device 300 may further receive the control information 520 in a control signal, e.g., DCI, or the client device 300 may receive the control information 520 in the common data stream and/or in the individual data stream.

In step II in FIG. 6, the client device 300 processes at least one part of the common data stream based on the control information 520. From the control information 520, the client device 300 obtains the indicated one or more types of the common data stream and/or one or more instructions associated with the common data stream and processes at least one part of the common data stream based on this information. When the control information 520 is given in a bit map format, the client device 300 may derive the bit map format from the predefined tables, e.g., Table 1 and 2 above. In other words, the client device 300 may derive the indicated types of the common data stream and/or instructions associated with the common data stream from the predefined tables and determine how to handle parts of the common data stream based on the derived information.

The common data stream is addressed to the plurality of client devices 300a, 300b, . . . , 300n and may comprise parts of the common data stream for each client device 300, i.e., subsets of bits for each client device 300. The client device 300 decodes the common data stream and may hence obtain parts of the common data stream for the other client devices 300 among the plurality of client devices 300a, 300b, . . . , 300n. Based on the decoded bits of the common data stream and the information from the control information 520, i.e., the types of the common data stream and/or instructions associated with the common data stream, the client device 300 processes parts of the common data stream. Depending on the information indicated control information 520, the client device 300 may determine to perform one or more actions.

In step III in FIG. 6, the client device 300 may hence perform an action based on the common data stream and the control information 520. For example, the control information 520 may indicate that the type of the common data stream comprises positioning data. In this case, the client device 300 may use the common data stream to obtain the position of other client devices 300 and use the common data stream for better estimation of its own position, or for avoiding interfering with the other client devices 300. If the control information 520 indicates that the type of the common data stream comprises data for AI/ML, the client device 300 may use the common data stream for training of one or more AI/ML models. The control information 520 may further indicate semantic information which may convey the true meaning of the bits transmitted as individual data streams and hence be used by the client device 100 to interpret the individual data streams.

When the instruction associated with the common data stream comprise any of discard at least one part of the common data stream addressed for another client device 300 and relay at least one part of the common data stream to another client device 300, the client device 300 act accordingly. Step III in FIG. 6 may hence comprise the client device 300 discarding the part of the common data stream addressed for the other client device 300, or relaying the part of the common data stream to the other client device 300. For example, when a part of the common data stream has private meaning for a first client device 300a, the client device 300 may relay this part of the common data stream to the first client device 300a based on the control information. The instruction associated with the common data stream may further instruct a subset of the plurality of client devices 300a, 300b, . . . , 300n to process one or more parts of the common data stream in a specific way and take specific action based on the parts of the common data stream.

The network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access nodes may be of different classes or types such as e.g., macro eNodeB, home eNodeB or pico base station, based on transmission power and thereby the cell size. The radio network access node may further be a station, which is any device that contains an IEEE 802.11-conformant MAC and PHY interface to the WM. The radio network access node may be configured for communication in 3GPP related LTE, LTE-advanced, 5G wireless systems, such as NR and their evolutions, as well as in IEEE related Wi-Fi, WiMAX and their evolutions.

The client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant media access control (MAC) and physical layer (PHY) interface to the wireless medium (WM). The UE may be configured for communication in 3GPP related long term evolution (LTE), LTE-advanced, fifth generation (5G) wireless systems, such as new radio (NR), and their evolutions, as well as in IEEE related Wi-Fi, worldwide interoperability for microwave access (WiMAX) and their evolutions.

Furthermore, any method according to embodiments of the invention may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the network access node and the client device comprise the necessary communication capabilities in the form of e.g., functions, means, units, elements, etc., for performing or implementing embodiments of the invention. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the network access node and the client device may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

1. A network access node (100) for a communication system (500), the network access node (100) being configured to:
transmit data streams (510) to a plurality of client devices (300a, 300b, . . . , 300n), the data streams (510) comprising: at least one common data stream addressed to the plurality of client devices (300a, 300b, . . . , 300n) and a plurality of individual data streams, each individual data stream being addressed to an individual client device (300n) among the plurality of client devices (300a, 300b, . . . , 300n); and
transmit a control information (520) to the plurality of client devices (300a, 300b, . . . , 300n), the control information (510) indicating one or more types of the common data stream and/or one or more instructions associated with the common data stream.

2. The network access node (100) according to claim 1, configured to:
transmit the control information (520) previous to or during the transmission of the data streams (510).

3. The network access node (100) according to claim 1, configured to:
transmit the control information (520) in the common data stream and/or in the plurality of individual data streams.

4. The network access node (100) according to claim 1, configured to:
transmit the control information (520) in a control signal.

5. The network access node (100) according to claim 4, wherein the control signal comprises a downlink control information.

6. The network access node (100) according to claim 1, wherein the control information (520) is given in a bit map format.

7. The network access node (100) according to claim 1, wherein the bit map format is derived from a predefined table.

8. The network access node (100) according to claim 1, wherein the one or more types of the common data stream comprise any of broadcast data and individual data.

9. The network access node (100) according to claim 1, wherein the one or more types of the common data stream comprise any of positioning data and data for artificial intelligence/machine learning.

10. The network access node (100) according to claim 1, wherein the one or more instructions associated with the common data stream comprise any of discard at least one part of the common data stream addressed for another client device and relay at least one part of the common data stream to another client device.

11. The network access node (100) according to claim 1, wherein the transmission of the data streams (510) is a rate splitting multiple access transmission.

12. A client device (300) for a communication system (500), the client device (300) being configured to:
receive at least one common data stream and at least one individual data stream from a network access node (100), the common data stream being addressed to a plurality of client devices (300a, 300b, . . . , 300n) and the individual data stream being addressed to the client device (300);
receive a control information (520) from the network access node (100), the control information (520) indicating one or more types of the common data stream and/or one or more instructions associated with the common data stream; and
process at least one part of the common data stream based on the control information (520).

13. The client device (300) according to claim 12, configured to:
receive the control information (520) previous to or during the transmission of the data streams (510).

14. The client device (300) according to claim 12, configured to:
receive the control information (520) in the common data stream and/or in the individual data stream.

15. The client device (300) according to claim 12, configured to:
receive the control information (520) in a control signal.

16. The client device (300) according to claim 12, wherein the control signal comprises a downlink control information.

17. The client device (300) according to claim 12, wherein the control information (520) is given in a bit map format.

18. The client device (300) according to claim 12, wherein the bit map format is derived from a predefined table.

19. The client device (300) according to claim 12, wherein the one or more types of the common data stream comprise any of broadcast data and individual data.

20. A non-transitory computer-readable storage medium, wherein storage medium coupled to one or more processors and storing programming instructions for execution by the one or more processors, the programming instructions instruct the processor to:
receive at least one common data stream and at least one individual data stream from a network access node (100), the common data stream being addressed to a plurality of client devices (300a, 300b, . . . , 300n) and the individual data stream being addressed to the client device (300);
receive a control information (520) from the network access node (100), the control information (520) indicating one or more types of the common data stream and/or one or more instructions associated with the common data stream; and
process at least one part of the common data stream based on the control information (520).
